(19) United States
(12) Patent Application Publication
(10) Pub. No.: US 2016/0223342 A1
(43) Pub. Date: Aug. 4, 2016

(54) Navigation System

(71) Applicant: AWTY Logistics, LLC, Dickinson, ND (US)

(72) Inventors: Paula Elizabeth Vreswyk, Dickinson, ND (US); Ryan C. Schlesinger, Grand Forks, ND (US); Justin W. Auch, Grand Forks, ND (US)

(73) Assignee: AWTY Logistics, LLC

(21) Appl. No.: 14/608,930

(22) Filed: Jan. 29, 2015

(51) Int. Cl. G01C 21/26

(52) U.S. Cl. CPC G01C 21/26

(57) ABSTRACT

A navigation system for providing navigation and information related to resource extractors such as wells within a given geographical area. The navigation system generally includes a central communication unit including a database of map and well data related to a geographical area and a user device including a software application stored on its memory. The user device will periodically connect to the central communication unit, such as upon being turned on, to update map and well data locally stored within the user device's memory. By locally storing the map and well data in the memory of the user device, the software application may provide a wide range of functionality, including navigation and details about each well, without the requirement of a constant connection with an outside server which can lead to issues such as high data usage or impaired performance.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a navigation system and more specifically it relates to a navigation system for providing offline navigation and information related to resource extractors such as wells within a given geographical area.

2. Description of the Related Art

Any discussion of the related art throughout the specification should in no way be considered as an admission that such related art is widely known or forms part of common general knowledge in the field.

Navigation systems have been in use for many years. Such navigation systems are commonly offered on user devices such as GPS devices, mobile phones, tablets, and the like. In typical prior art systems, such a user device establishes a continuous connection with a central mapping server. During use, data is constantly being streamed between the user device and the central mapping server. This constant streaming and reliance on data retrieved online leads to a numerous drawbacks, including lag created by constant streaming and potential high data charges.

Prior art navigation systems also typically include the entire world or an entire country within its map display. While this may be suitable for world travelers, it is not ideal for individuals who frequent the same geographical area repeatedly, such as truckers who frequent oil fields to service oil wells. By focusing on breadth rather than detail, these prior art systems also typically omit private roads, such as oil lease roads, and thus include only public roads. Failing to include such private roads can lead to less optimized routing when traveling using such prior art systems.

Because of the inherent problems with the related art, there is a need for a new and improved navigation system for providing offline navigation and information related to resource extractors such as wells within a given geographical area.

### BRIEF SUMMARY OF THE INVENTION

The invention generally relates to a navigation system which includes a central communication unit including a database of map and well data related to a geographical area and a user device including a software application stored on its memory. The user device will periodically connect to the central communication unit, such as upon being turned on, to update map and well data locally stored within the user device's memory. By locally storing the map and well data in the memory of the user device, the software application may provide a wide range of functionality, including navigation and details about each well, without the requirement of a constant connection with an outside server which can lead to issues such as high data usage or impaired performance.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram of an exemplary computer system for use with the present invention.

FIG. 2a is a block diagram illustrating the interconnection between the central communication unit and the user device upon connection and/or disconnection of the user device.

FIG. 2b is a block diagram illustrating that the central communication unit and the user device are not connected during usage of the user device.

FIG. 3 is an illustration of a start-up screen for the user interface of the present invention prior to downloading map and well data.

FIG. 4 is an illustration of a start-up screen for the user interface of the present invention after downloading map and well data.

FIG. 5 is an illustration of an exemplary map display of the present invention.

FIG. 6 is an illustration of an exemplary well listing of the present invention.

FIG. 7 is an illustration of the search bar being used to search for a well.

FIG. 8a is an illustration of a well menu of the present invention.

FIG. 8b is an illustration of well details of the present invention.

FIG. 9 is an illustration of a navigation display of the present invention.

FIG. 10 is an illustration of a directions display of the present invention.

FIG. 11 is an illustration of an options menu of the present invention.

FIG. 12 is an illustration of the map display after the “back” button has been pressed once.

FIG. 13 is an illustration of the map display after the “back” button has been pressed twice.

FIG. 14 is a flowchart illustrating the initial start-up of the user device of the present invention.

FIG. 15 is a flowchart illustrating search functionality for a well using the present invention.

FIG. 16 is a flowchart illustrating well menu functionality with the present invention.

FIG. 17 is a flowchart illustrating functionality of the user location selector of the present invention.

FIG. 18 is a flowchart illustrating navigation functionality of the present invention.

FIG. 19 is a flowchart illustrating well details functionality of the present invention.

FIG. 20 is a flowchart illustrating close-down functionality of the present invention.

FIG. 21 is a flowchart illustrating the central communication unit correlating navigational data with map and well data.

### DETAILED DESCRIPTION OF THE INVENTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a communications network, such as the Internet.

### A. Overview of Invention.

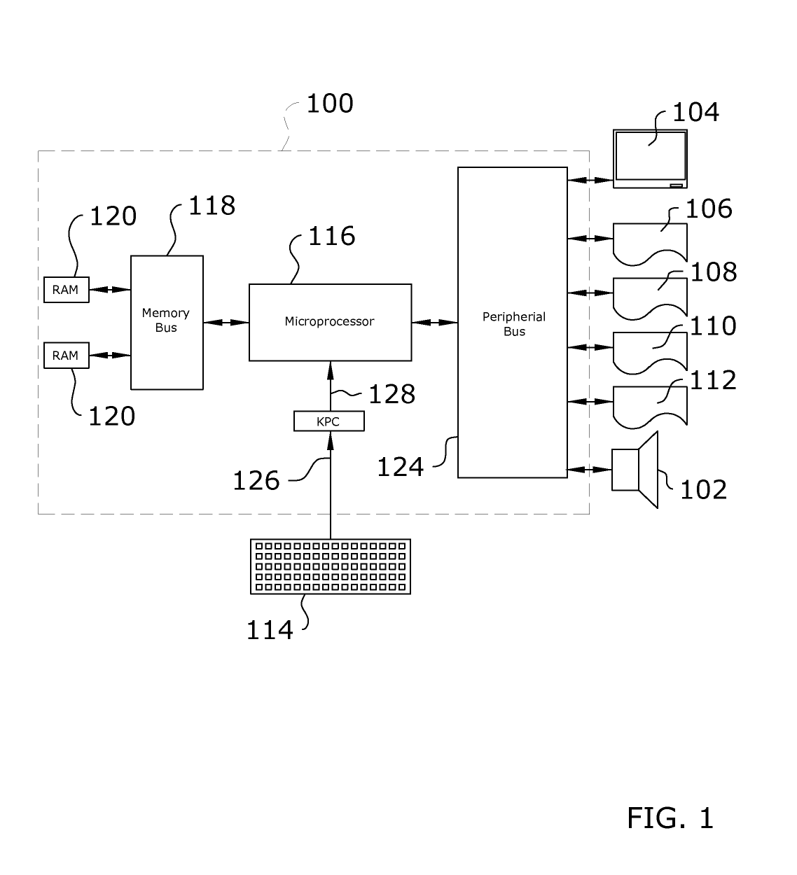

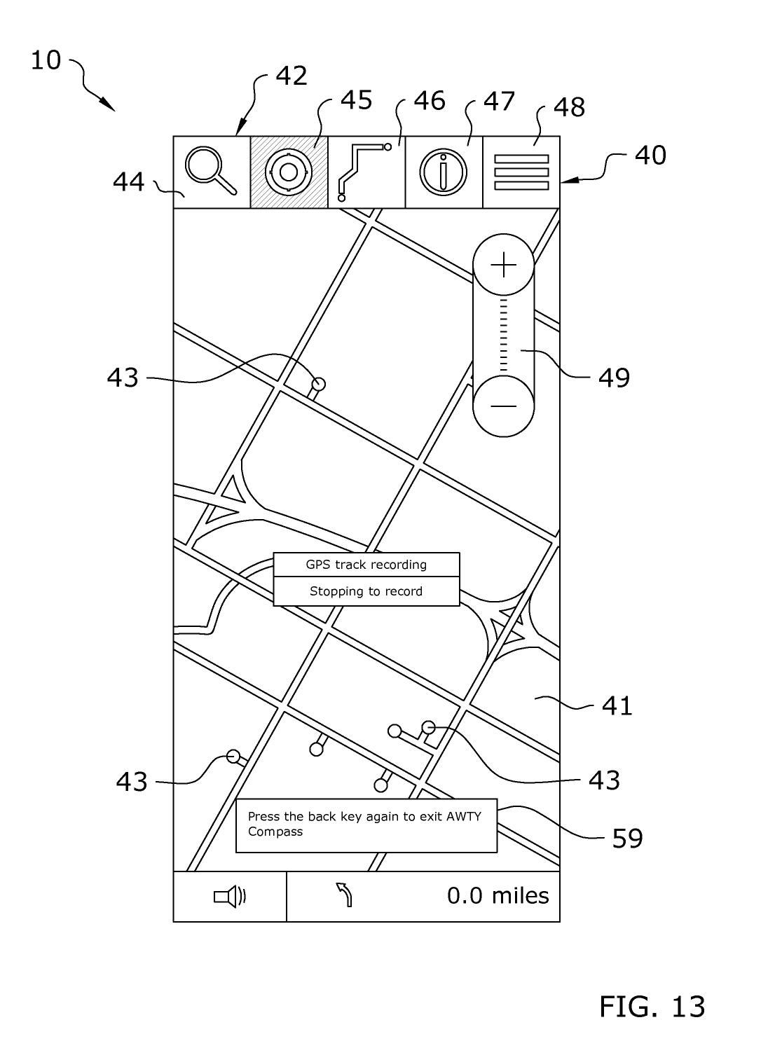

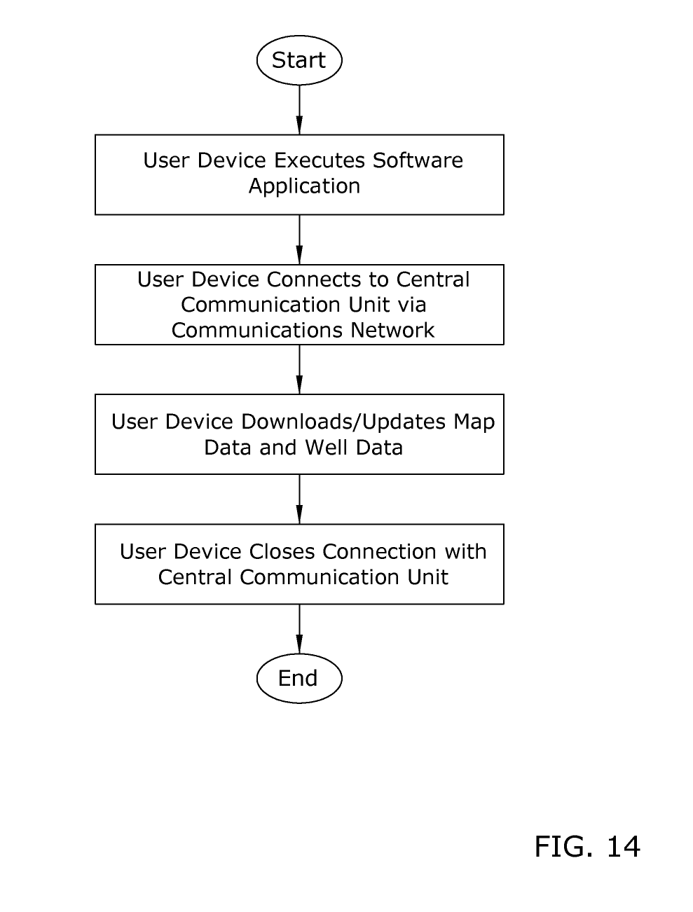

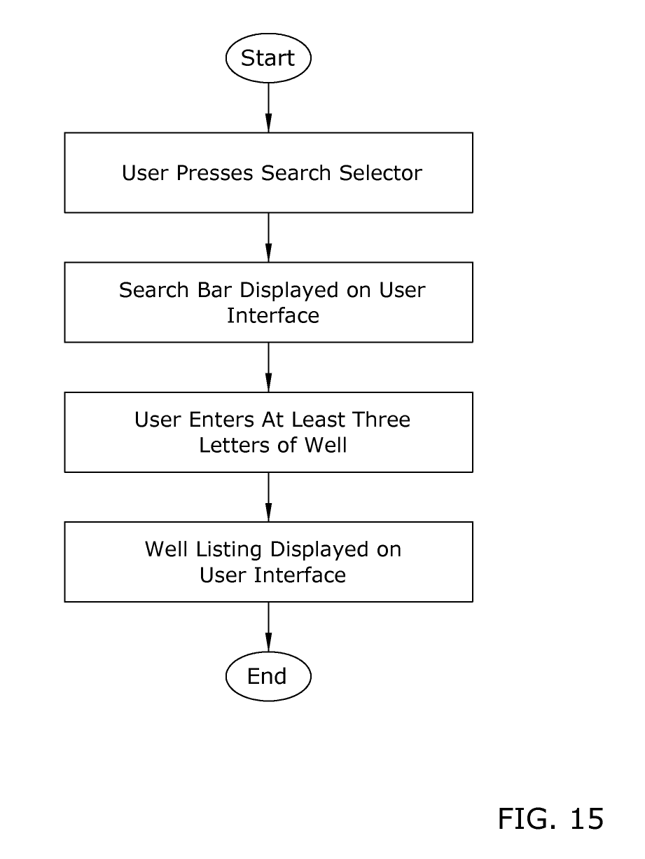

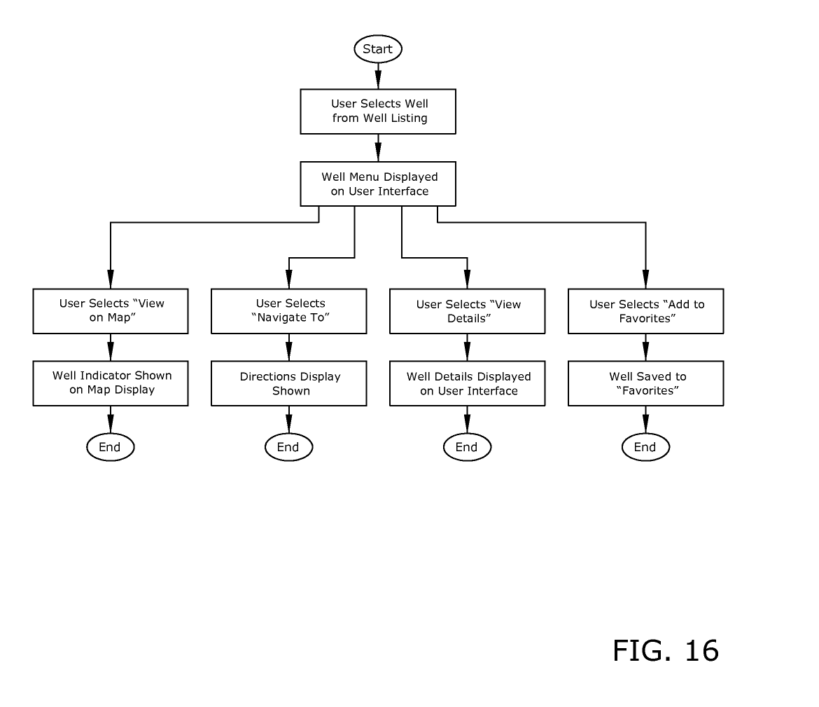

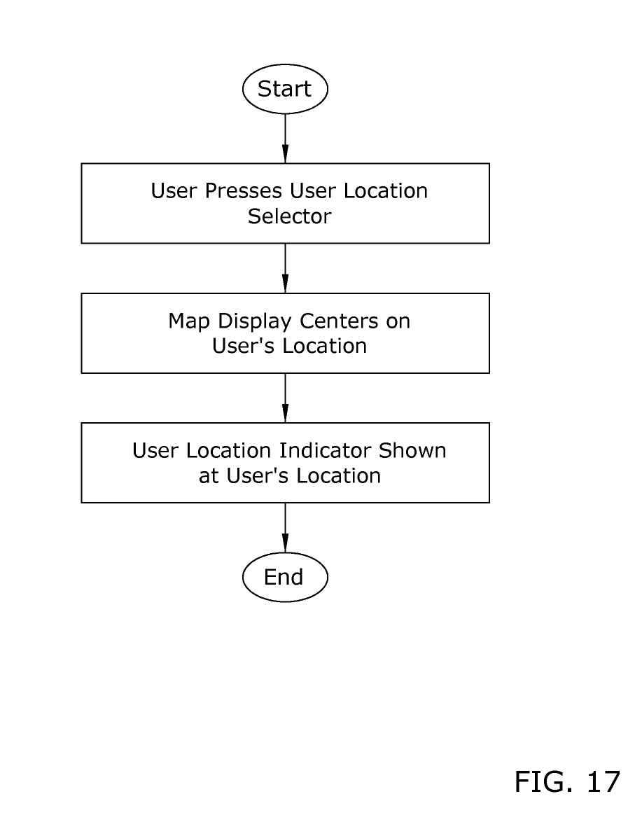

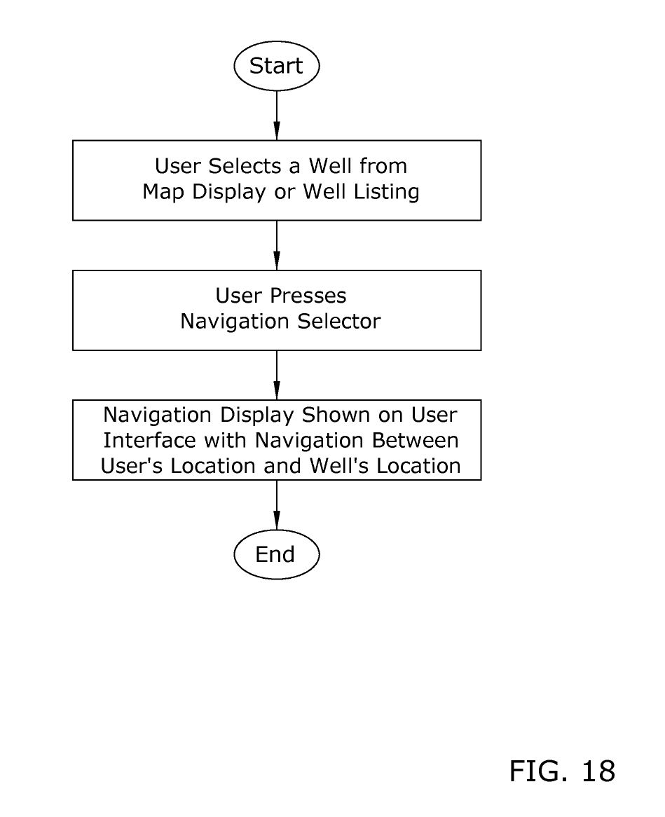

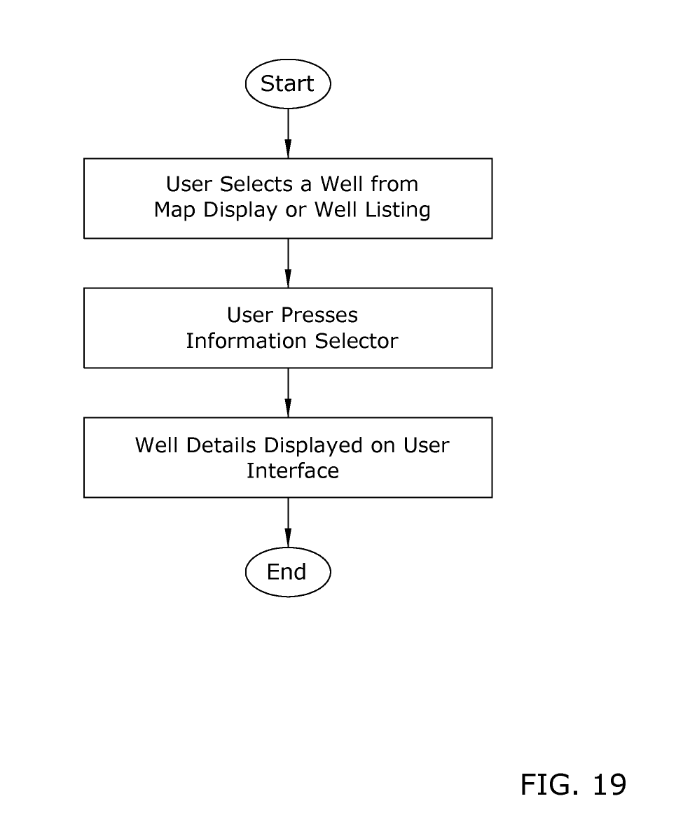

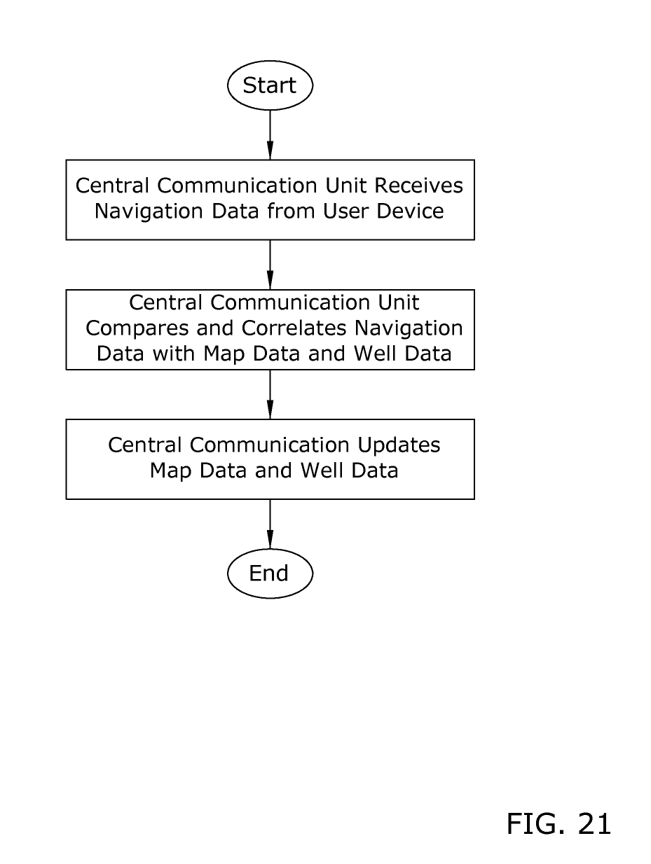

FIGS. 1-21 illustrate the present invention. The navigation system 10 described herein generally includes a central communication unit 20 and a user device 30. At certain times during operation of the present invention, the central communication unit 20 and the user device 30 will be communicatively interconnected via a communications network 12. It should be appreciated that the user device 30 need not be continuously connected to the central communication unit 20 to provide the functionality of the present invention.

The central communication unit 20 is adapted to store, maintain, and update map data and well data relating to a geographical area within a database 22. It should be appreciated that the term “well” within the present application can refer to any resource-extraction device, including wells, rigs, and the like. The present invention should also not be construed as limited to any particular resource such as oil.

The user device 30 will periodically communicate with the central communication unit 20 to update the map data and well data, which are both locally stored on the user device 30 via its memory 34. A software application 34 on the user device 30 utilizes the map data and well data stored within the memory 32 of the user device 30 to perform various functionality, including providing navigation to one or more wells within the geographical area as well as providing valuable information about each of the wells.

### B. Exemplary Computer System.

FIG. 1 is a block diagram of an exemplary computer system 100 for practicing the various aspects of the present invention, such as the central communication unit 20. The computer system 100 includes a display screen (or monitor) 104, a printer 106, a floppy disk drive 108, a hard disk drive 110, a network interface 112, and a keyboard 114. The computer system 100 also includes a microprocessor 116, a memory bus 118, random access memory (RAM) 120, read only memory (ROM) 122, a peripheral bus 124, and a keyboard controller 126. Computer system 100 can be a personal computer (such as an APPLE computer, an IBM computer, or one of the compatibles thereof), a workstation computer (such as a SUN MICROSYSTEMS or HEWLETT-PACKARD workstation), or various other types of computers. It can be appreciated that the computer system 100 may be comprised of various other electronic devices including but not limited to mobile phones, telephones, personal digital assistants (PDAs), handheld wireless devices, two-way radios, smart phones, communicators, video viewing units, television units, television receivers, cable television receivers, pagers, communication devices, and digital satellite receiver units.

The microprocessor 116 is a general-purpose digital processor that controls the operation of the computer system 100. Microprocessor 116 can be a single-chip processor or implemented with multiple components. Using instructions retrieved from memory, microprocessor 116 controls the reception and manipulations of input data and the output and display of data on output devices.

The memory bus 118 is utilized by the microprocessor 116 to access the RAM 120 and the ROM 122. RAM 120 is used by microprocessor 116 as a general storage area and as scratch-pad memory, and can also be used to store input data and processed data. ROM 122 can be used to store instructions or program code followed by microprocessor 116 as well as other data.

Peripheral bus 124 is used to access the input, output and storage devices used by the computer system 100. In the described embodiment(s), these devices include a display screen 104, a printer device 106, a floppy disk drive 108, a hard disk drive 110, and a network interface 112. A keyboard controller 126 is used to receive input from the keyboard 114 and send decoded symbols for each pressed key to microprocessor 116 over bus 128.

The display screen 104 is an output device that displays images of data provided by the microprocessor 116 via the peripheral bus 124 or provided by other components in the computer system 100. The printer device 106 when operating as a printer provides an image on a sheet of paper or a similar surface. Other output devices such as a plotter, typesetter, etc. can be utilized in place of, or in addition to, the printer device 106.

The floppy disk drive 108 and the hard disk drive 110 can be utilized to store various types of data. The floppy disk drive 108 facilitates transporting such data to other computer systems, and the hard disk drive 110 permits fast access to large amounts of stored data.

The microprocessor 116 together with an operating system operate to execute computer code and produce and use data. The computer code and data may reside on RAM 120, ROM 122, or hard disk drive 110. The computer code and data can also reside on a removable program medium and loaded or installed onto computer system 100 when needed. Removable program mediums include, for example, CD-ROM, PC-CARD, floppy disk and magnetic tape.

The network interface circuit 112 is utilized to send and receive data over a network connected to other computer systems. An interface card or similar device and appropriate software implemented by microprocessor 116 can be utilized to connect the computer system 100 to an existing network and transfer data according to standard protocols.

The keyboard 114 is used by a user to input commands and other instructions to the computer system 100. Other types of user input devices can also be used in conjunction with the present invention. For example, pointing devices such as a computer mouse, a track ball, a stylus, or a tablet to manipulate a pointer on a screen of the computer system 100.

The present invention can also be embodied as computer readable code on a computer readable medium. The computer readable medium is any data storage device that can store data which can be thereafter be read by a computer system. Examples of the computer readable medium include read-only memory, random-access memory, magnetic data storage devices such as diskettes, and optical data storage devices such as CD-ROMs. The computer readable medium can also be distributed over a network coupled computer systems so that the computer readable code is stored and executed in a distributed fashion.

The present invention may be embodied within various languages and technologies such as but not limited to JAVA, JAVASCRIPT, JSCRIPT, WMLSCRIPT, ACTIVEX, CGI, scripts, plug-ins, BASIC, VISUAL BASIC, C, C++, COBOL, FORTRAN, ADA, HTML, DHTML, XML, SGML, WML, HDML, FLASH, SHOCKWAVE, GIF, JPEG, ADOBE ACROBAT, PDF, MICROSOFT WORD, and PASCAL. The present invention may be operated upon various operating systems such as but not limited to UNIX, MACINTOSH, LINUX, WINDOWS, PALMOS, EPOC, WINDOWS CE, FLEXOS, OS/9, and JAVAOS.

### C. Exemplary Communications Network.

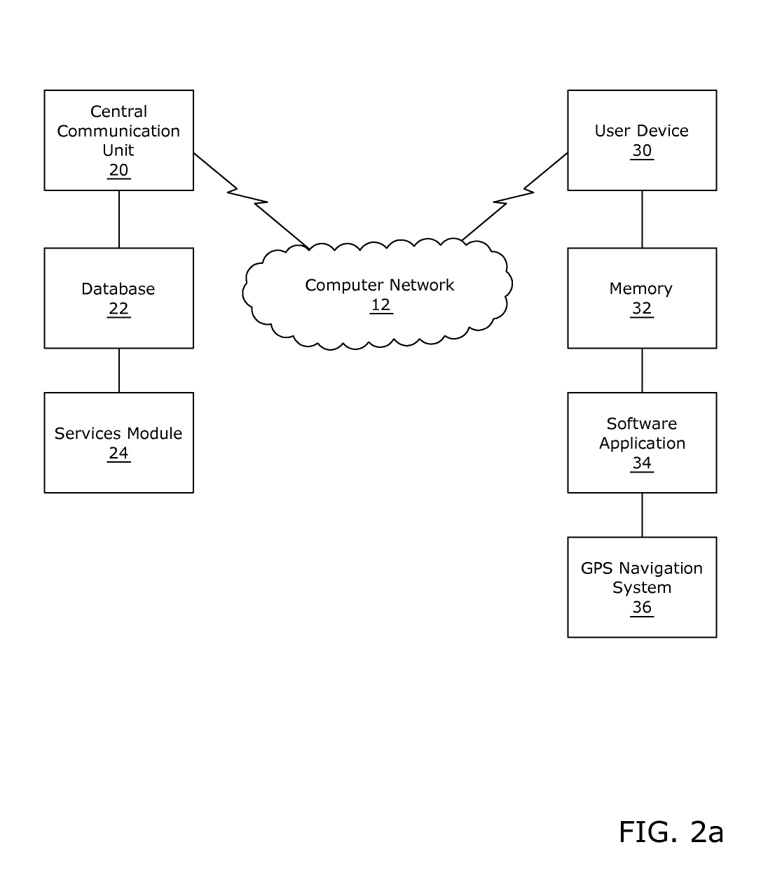

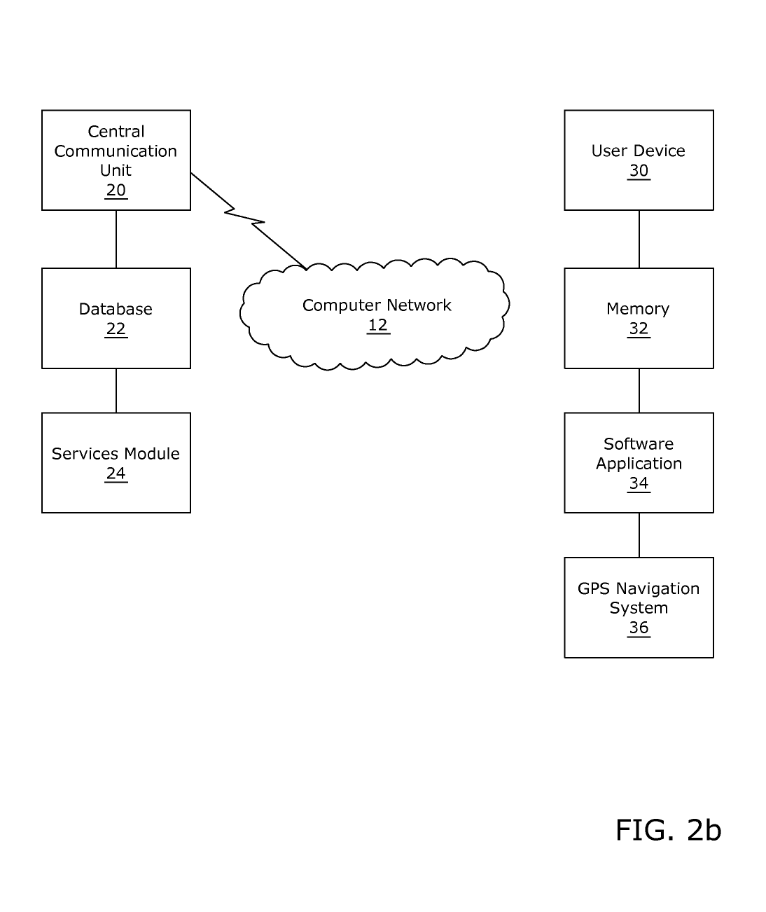

As shown in FIGS. 2a and 2b, the Internet 12 is an exemplary communications network 12 for the present invention. The Internet 12 is basically comprised of a “global computer network.” One or more user devices 30 around the world may communicate separately with the central communication unit 20 via this global computer network to periodically transfer data (such as map data and well data) between the user devices 30 and the central communication unit 20. The communications between the user device(s) 30 and the central communication unit 20 may be accomplished via various methods such as but not limited to wireless, Ethernet, cable, direct connection, telephone lines, and satellite. One or more web servers may also provide data to the various components of the present invention connected via the Internet 12.

The present invention may also be utilized upon global computer networks, local area networks (LAN), wide area networks (WAN), campus area networks (CAN), metropolitan-area networks (MAN), and home area networks (HAN). Various protocols may be utilized by the electronic devices for communications such as but not limited to HTTP, SMTP, FTP and WAP (Wireless Application Protocol). The present invention may be implemented upon various wireless networks such as but not limited to CDPD, CDMA, GSM, PDC, PHS, TDMA, FLEX, REFLEX, IDEN, TETRA, DECT, DATATAC, and MOBITEX. The present invention may also be utilized with online services and internet service providers such as AMERICA ONLINE (AOL), COMPUSERVE, WEBTV, and MSN INTERNET SERVICES. The present invention preferably utilizes the Internet 12 for transmitting data, however it can be appreciated that as future technologies are created that various aspects of the invention may be practiced with these improved technologies.

### D. Central Communication Unit.

The central communication unit 20 may be comprised of any central communication device or system where communications are preferably established with by the user device 30 to periodically download map data and well data to perform the various functions of the present invention. While the singular term “unit” is used throughout the application, it should be appreciated that the central communication unit 20 may be comprised of a plurality of units which, together, perform the various functions set out herein.

The central communication unit 20 may be comprised of one or more server computers, cloud based computers, virtual computers, home computers or other computer systems capable of receiving and transmitting data via IP networks and the communications networks 12. The central communication unit 20 may be comprised of any electronic system capable of receiving and transmitting information (e.g. voice data, computer data, etc.).

The central communication unit 20 may host a website or application which is utilized in combination with the one or more user devices 30 to perform the various functionalities of the present invention. The central communication unit 20 is preferably periodically communicatively interconnected with the user device(s) 30 through the communications network 12.

As best shown in FIGS. 2a and 2b, the central communication unit 20 is preferably comprised of an off-location computing device (such as one or more server computers) which is adapted to transmit and receive data with the one or more user devices 30 of the present invention. The central communication unit 20 may be implemented across multiple devices or may be comprised of a single computing device. In embodiments implementing the central communication unit 20 across multiple devices, those devices may themselves be interconnected via a communications network 12.

As shown in FIG. 2a, the central communication unit 20 includes a database 22 which stores various data including map data and well data. This data is periodically updated through intermittent connections with the user devices 30 of the present invention. The database 22 generally comprises a database which is either stored upon or communicatively interconnected with the central communication unit 20. The database 22 may be stored entirely on a single device or may be implemented across multiple devices. The database 22 may be integral with the central communication unit 20 or may be stored on a completely different device (or devices) which are communicatively interconnected with the central communication unit 20, such as through a communications network 12.

The map and well data may be updated automatically or manually from the various user devices 30 in use through the communications network 12. In a preferred embodiment, the central communication unit 20 will be adapted to automatically and periodically update data in the database 22, such as through retrieving data from a user device 30 every time the user device 30 terminates its software application 34.

The two primary types of data retained and updated by the central communication unit 20 within its database 22 are map data and well data. It should be appreciated, however, that additional data may be routinely stored, updated, and accessed within the database 22, such as usage statistics of the various user devices 30 used with the present invention and the like. Navigation data from the user devices 30 will be correlated with the map data and well data to ensure that the map data and well data are kept up-to-date.

To improve functionality over prior art systems, the present invention utilizes a system in which map data and well data are both stored and maintained on the central communication unit 20. As shown in FIG. 2a, upon first connecting to the central communication unit 20, the user device 30 will download the map data and user data, such as via the communications network 12, and store that map data and user data within its memory 32. This methodology significantly reduces data transfer usage on the user device 30 and allows the software application 34 of the user device 30 to function more seamlessly and smoothly by not requiring the constant streaming of data between the central communication unit 20 and the user device 30.

Map data stored within the database 22 will generally relate to a specific geographic area, such as an oil-producing region. Rather than loading and storing map data which is not relevant to the needs of the individual using the present invention, the map data will focus on the specific geographic area being serviced by that specific embodiment of the present invention. For example, one embodiment of the present invention may be directed toward a first oil-producing region (such as the Bakken formation in the Upper Midwest of the United States) while a second embodiment of the present invention may be directed toward a second oil-producing region (such as the East Texas Oil Field).

The above-referenced approach allows for the map data to include far more detailed information regarding the specific region than would be possible if the map data included the entire country or world, as only the data relevant to the user's specific region will be transferred, accessed, and maintained. For example, while typical mapping systems include public roads, they often omit private roads, such as oil lease roads which are common in oil-producing regions.

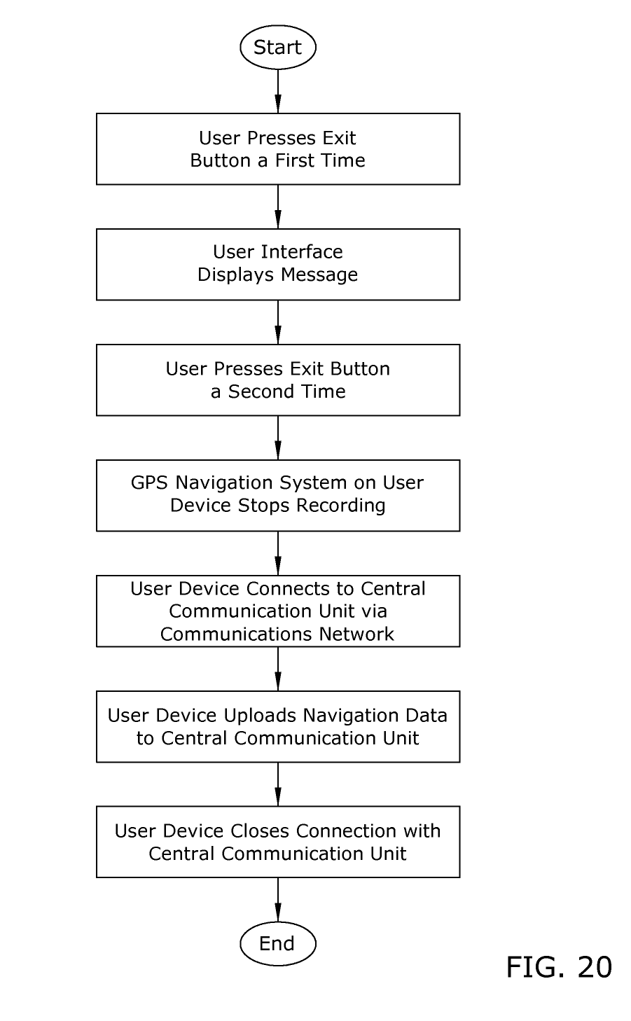

By focusing on a specific oil-producing region, the present invention is capable of storing far more detailed information regarding that region, such as the private roads, trails, and passageways which are commonly omitted from other mapping software. This information is updated and maintained by the user devices 30 themselves, which provide navigational data related to such roads, trails, and passageways in the oil-producing region to the central communication unit 20 at the conclusion of operation of the software application 34 as discussed herein and shown in FIG. 20.

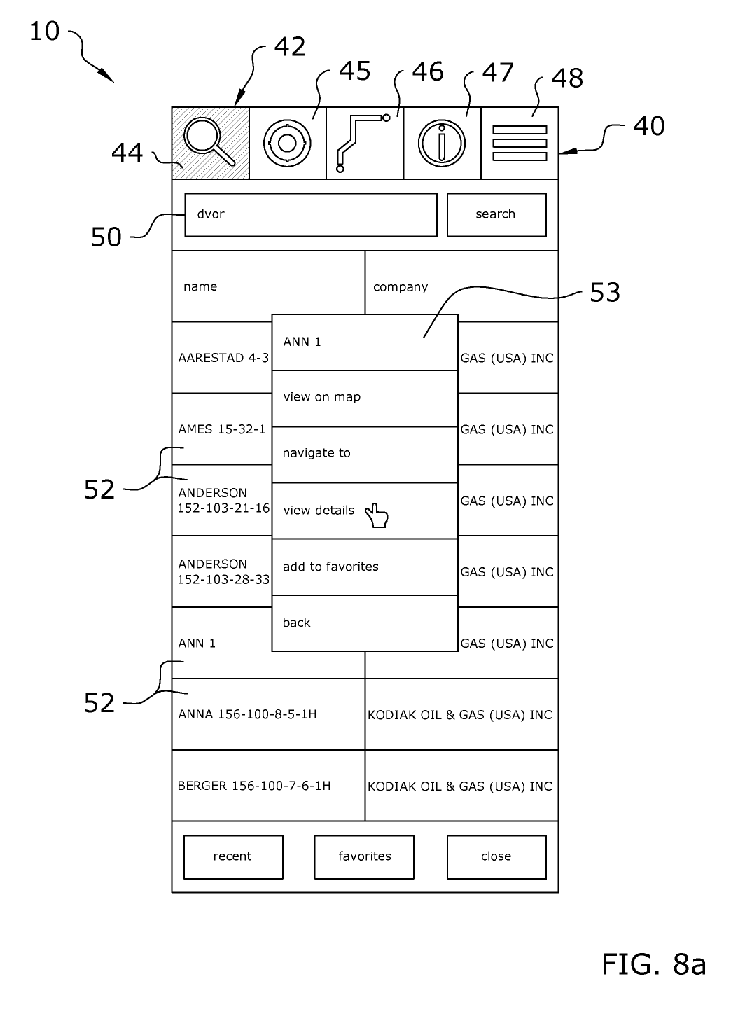

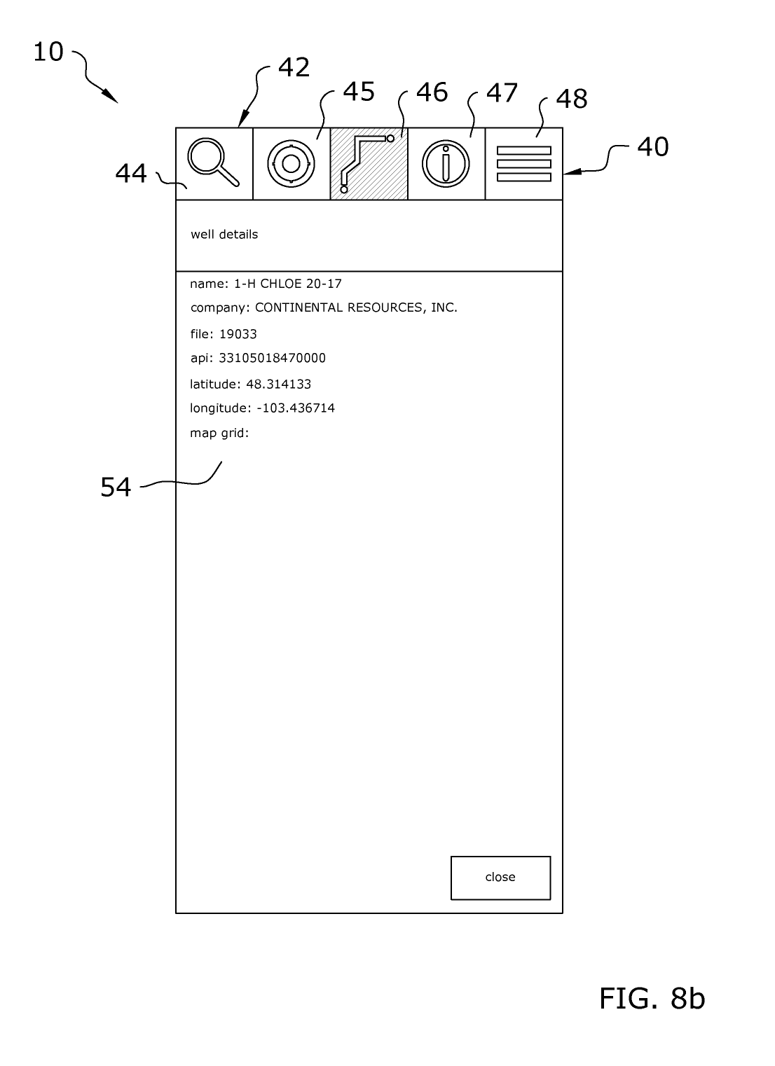

Well data stored on the central communication device 20 relates to oil and other resource-extracting wells within the geographical area covered by the present invention. An example of information stored within the well data is shown in FIG. 8b. Well data may include such information as the location of the well (including longitudinal and latitudinal coordinates), the name of the well, the company owning the well, any file or well number which may be associated with the well (such as by regulatory agencies, the owner of the well, etc.) and any API key associated with that well which may aid with integration with other systems or programs.

As shown in FIG. 2a, the central communication unit 20 generally implements a services module 24 which interacts with the user device 30 through the software application 34. The services module 24 provides the data, including well data and map data, required by the software application 34 of the user device 30 to implement the various features of the present invention. As noted, the transfer of such data from the central communication unit 20 to the user device 30 occurs only periodically, such as upon initial activation of the software application 34, and thus does not generally occur continuously during operation of the present invention.

The services module 24 will also oversee the maintenance and updating of map and well data within the database 22 of the central communication unit 20. Map data and well data are generally received by the central communication unit 20 upon disconnection of a user device 30. This data is stored in the database 22 and processed by the services module 24. The services module 24 will review the data related to the navigational movements of the relevant user device 30 as well as the wells visited and update the locally-stored map and well data on the server-side to be more accurate.

For example, if a user travels a road that does not exist within the map data, the services module 24 will determine, based on usage by others, whether this road should be added to the server-side map data. If so, the map data and/or well data will be updated within the database 22 and the updated data will be transferred to future user devices 30 upon establishing an initial connection with the central communication device 20. This functionality may be performed in various manners. In one embodiment, a the user device 30 will transfer a file (such as a GPX file) to the central communication device 20 which details the route taken by the user device 30 during use. The data in this file may be integrated with the existing data in the database 22 to reflect more accurate mapping and routing.

### E. User Device.

The user device 30 may be comprised of any type of computing device for practicing the various aspects of the present invention. The user device 30 will preferably be adapted to communicate with the central communication unit 20 via the communications network 12 as shown in FIG. 2a. The user device 30 may connect with the central communication unit 20 via a website (i.e. through a web browser) or via a software application 34 (i.e. by downloading the application from a mobile application store, such as GOOGLE PLAY STORE or APPLE ITUNES).

By way of example, the user device 30 can be a personal computer (e.g. APPLE® based computer, an IBM based computer, or compatible thereof) or tablet computer (e.g. IPAD®). The user device 30 may also be comprised of various other electronic devices capable of sending and receiving electronic data including but not limited to smartphones, mobile phones, telephones, personal digital assistants (PDAs), mobile electronic devices, handheld wireless devices, two-way radios, smart phones, communicators, video viewing units, television units, television receivers, cable television receivers, pagers, communication devices, and digital satellite receiver units.

The present invention may be implemented and viewed upon various types and brands of web/e-mail browsers run on a user device 30 such as but not limited to MICROSOFT INTERNET EXPLORER, NETSCAPE NAVIGATOR, MOZILLA FIREFOX, SAFARI, OPERA, AMAYA, ARENA, LYNX, HOTJAVA, MOZILLA, ICAB, MICROSOFT OUTLOOK, and MICROSOFT OUTLOOK EXPRESS. Browsers for handheld wireless devices, often times referred to as “microbrowsers”, are also capable of implementing the present invention. A browser is typically capable of displaying/playing various types of content including but not limited text, graphic, audio and multimedia.

The present invention may also be implemented and viewed through a software application 34 similarly run on a user device 30. The software application 34 may be implemented through various operating systems such as but not limited to MICROSOFT WINDOWS, LINUX, APPLE IOS, ANDROID, and the like. The software application 34 may be distributed in physical form to be installed upon the user device 30 or may be distributed via the communications network 12.

As shown in FIG. 2b, the software application 34 of the user device 30 will generally implement all of the client-side code to perform various functions of the present invention. Such functions may include interacting with the user, displaying the user interface 40, receiving and processing instructions from the user, providing well information, and providing navigation. The software application 34 may be executed through the operating system of the user device 30 or through secondary software such as a web browser (i.e. the software application 34 may be implemented within a web browser, such as by using FLASH).

In a preferred embodiment, the software application 34 provides the functionality for navigating and examining the user interface 40 of the present invention, including examination of map data and well data, such as through the map display 41. The software application 34 generates the user interface 40 and other displays utilizing map data and well data received from the central communication unit 20 upon initial start-up of the software application 34. As mentioned, a direct, continuous connection with the central communication unit 20 is not necessary for proper functionality of the software application 34 after the map data and well data have been downloaded/updated upon start-up of the software application 34. FIG. 2b illustrates that the user device 30 is not communicatively interconnected with the central communication unit 20 during use.

The user device 30 will preferably include a GPS navigation system 36 as shown in FIGS. 2a and 2b. The GPS navigation system 36 may be integrated with the user device 30 or may be comprised of a separate device which is communicatively interconnected with the user device 30. In either case, the GPS navigation system 36 will aid in providing navigation to the user, such as by keeping track of the user's current location (represented by the user location indicator 39 on the user interface 40).

The GPS navigation system 36 of the user device 30 will be activated upon execution of the software application 34 if it was not previously activated. In a preferred embodiment, the software application 34 will not initiate until the GPS navigation system 36 has been activated. Upon activation, the GPS navigation system 36 will be utilized to track the user's current location and to provide aid in navigation to/from wells.

The movements of the user device 30 will be tracked by the GPS navigation system 36 and stored within the memory 32 of the user device 30 as navigational data. Upon closing the software application 34, the navigational data is transmitted to the central communication unit 20 (such as via a GPX file), which will process the navigational data and compare against map and well data to determine if the map and well data in its database 22 should be updated with new information from the user's navigational data.

### F. User Interface.

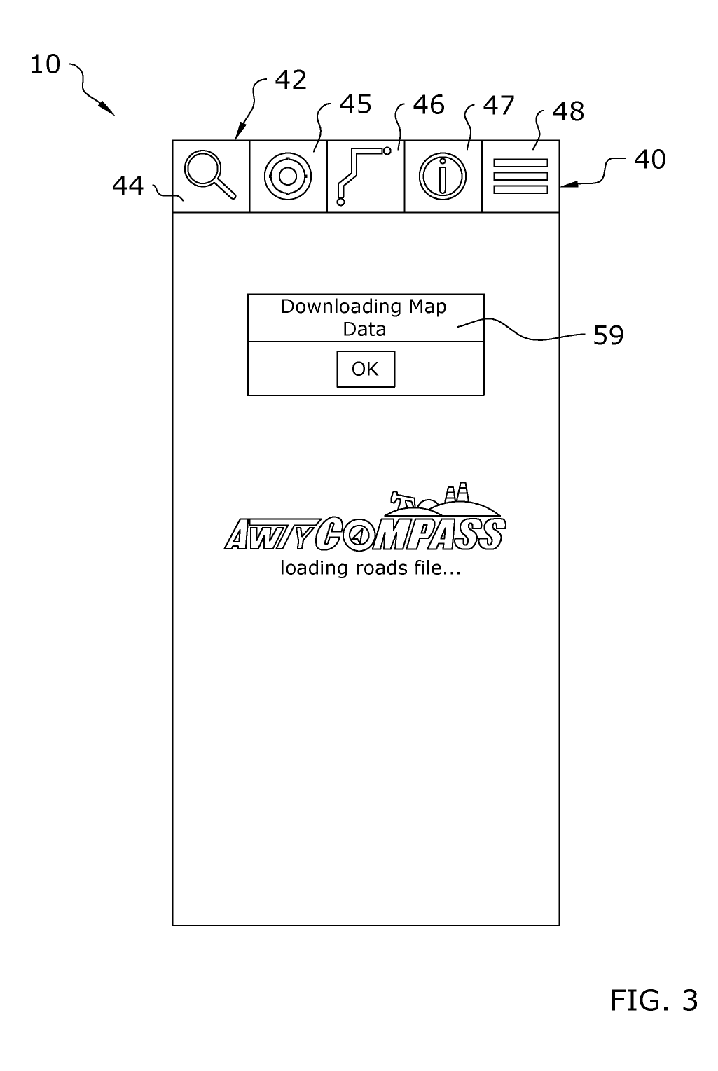

As illustrated in FIGS. 3-13, the present invention utilizes a user interface 40 which is displayed upon the user device 30. The appearance and configuration of the user interface 40 may vary in different embodiments of the present invention. The scope of the present invention should thus not be construed as being limited by the exemplary user interfaces 40 shown herein.

The user interface 40 is generated in a preferred embodiment of the present invention by the software application 34 of the user device 30 from a combination of map data and well data received from the central communication unit 20 and stored locally in the user device's 30 memory 32. By not necessitating a connection to the central communication unit 20 for functionality of the user interface 40, a smoother and more pleasant user experience is achieved due to data not being delayed by streaming.

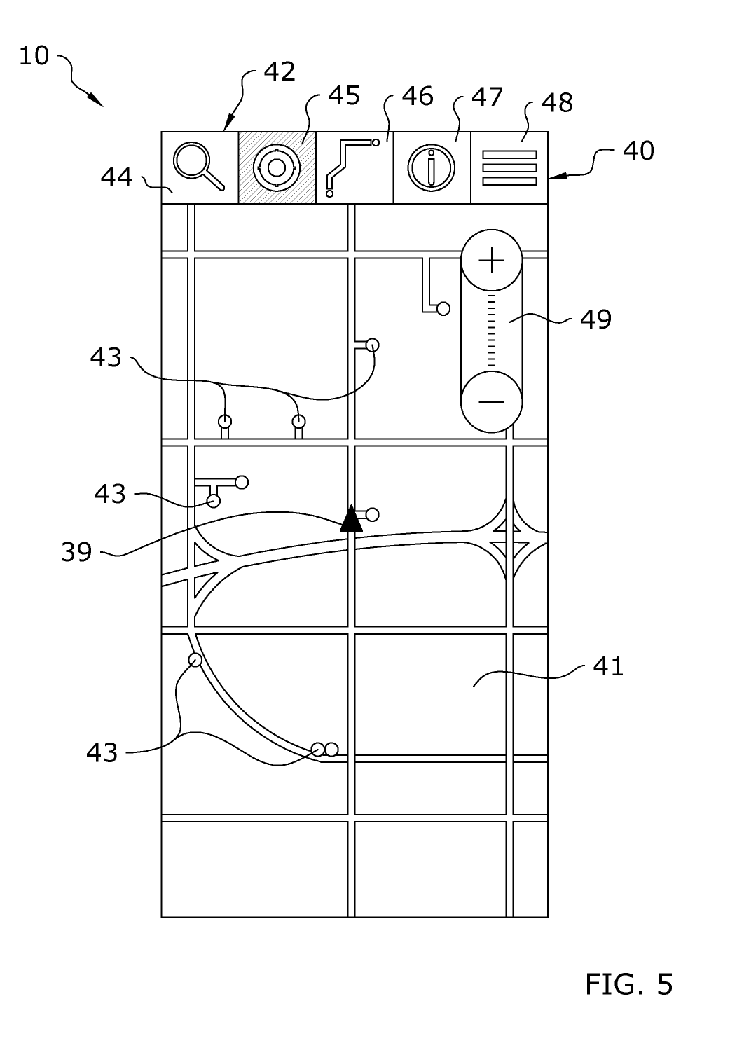

Exemplary user interfaces 40 are shown in FIGS. 3-13. As shown in FIG. 5, the user interface 40 will generally include a map display 41 which shows the geographic area covered by the present invention. The map display 41 may be zoomed in or out using a zoom selector 49. The map display 41 will generally show at least roads, wells, and the user's location. Road labels become available as the map display 41 is zoomed, and disappear as the map display 41 is zoomed out.

As best shown in FIG. 5, the user's location will be shown on the map display by a user location indicator 39. The wells will be shown on the map display 41 by well indicators 43. Although the figures illustrate that the user location indicator 39 comprises a triangle and the well indicators 43 comprise circles, it should be appreciated that other types of well indicators 43 may be utilized.

As shown throughout the figures, the user interface 40 will generally include a plurality of menu options displayed on a menu bar 42. The menu bar 42 will preferably extend horizontally across the upper end of the user interface 40 as shown in the figures. However, it should be appreciated that alternate orientations and locations may be utilized for the menu bar 42. For example, the menu bar 42 in some embodiments could extend vertically along one of the sides of the user interface 40. In some embodiments, the menu bar 42 may be adapted to fade away or minimize unless it is being accessed. In other embodiments, the location, orientation, and configuration of the menu bar 42 may be customizable by the user to improve the user experience with the present invention.

As best shown in FIGS. 3-10 and 12-13, the menu bar 42 includes a plurality of selectors 44, 45, 46, 47, 48 which may be selected by the user to perform various functions with the present invention. To activate a selector 44, 45, 46, 47, 48, a user will generally just press upon the desired selector 44, 45, 46, 47, 48 with either his/her finger (if the user device 30 supports touch screen functionality) or with a stylus, mouse pointer, or voice command.

The selectors 44, 45, 46, 47, 48 included in the menu bar 42 may vary in different embodiments and should not be construed as limited by the exemplary figures. In a preferred embodiment as shown in the figures, the menu bar 42 includes a search selector 44, a user location selector 45, a navigation selector 46, an information selector 47, and an options selector 48. The order of the selectors 44, 45, 46, 47, 48 may vary in different embodiments.

The zoom selector 49 is generally located in the map display 41 and not on the menu bar 42, though it could be implemented into the menu bar 42 in some embodiments of the present invention. The functionality of each of the selectors 44, 45, 46, 47, 48 of the present invention is described in the following section.

The user interface 40 may also include a search bar 50 which may be utilized to search for wells or other locations within the memory 32 of the user device 30. The search bar 50 may be utilized to pull up a well listing 52 which lists wells found using parameters entered into the search bar 50. A well details 54 screen may be utilized to show details of the selected well, and a well menu 53 may be provided to allow different options with respect to the selected well. The options menu 55 provides a plurality of options, some of which may be duplicative, which the user may utilize to perform various functionality.

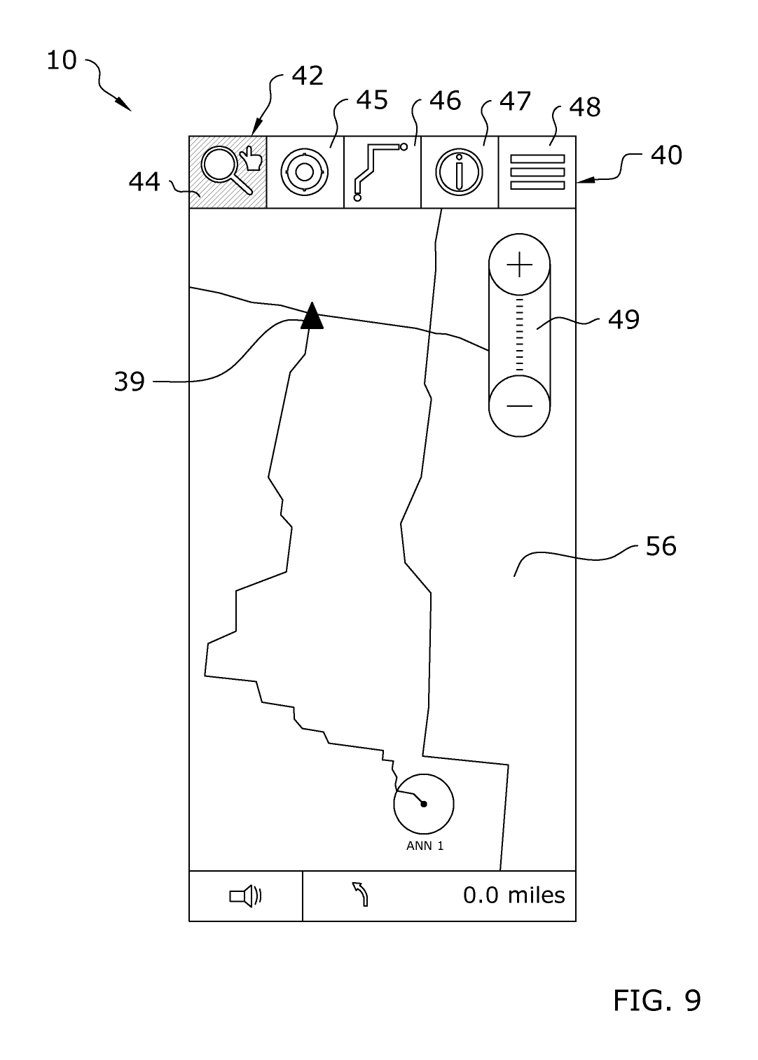

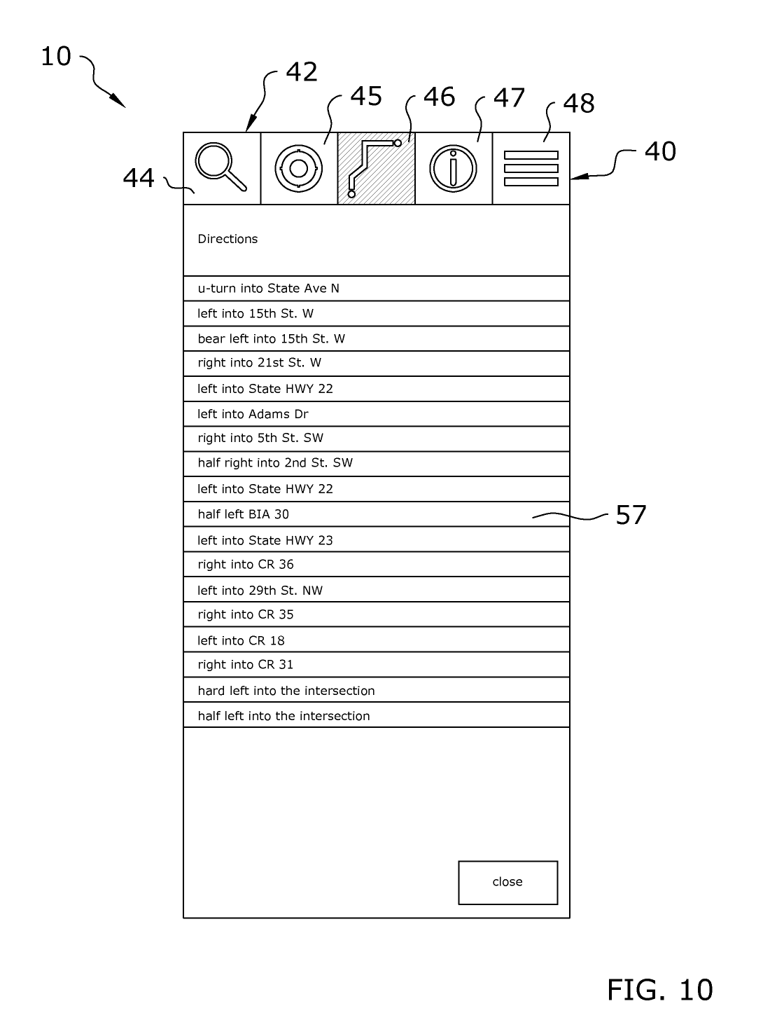

Finally, the user interface 40 may include displays in addition to the map display 42. A navigation display 56 may be presented which comprises a map display 42 with navigation lines shown between the user's location and the desired well(s) to which the user intends to travel to/from as shown in FIG. 9. A directions display 57 may also be included which provides step-by-step instructions for navigation as shown in FIG. 10. The user interface 40 may also include various messages 59 such as shown in FIGS. 3, 4, 12, and 13 to provide instructions or information to the user on various items. The functionality of the aforementioned features is discussed in the following section.

### G. Operation of Preferred Embodiment.

In use, the software application 34 is first loaded into the memory 32 of the user device 30. This may be achieved by downloading the software application 34 via a web browser or other source of software applications, such as the ITUNES APP STORE or ANDROID PLAY STORE. Alternatively, the software application 34 could be provided on a tangible medium, such as a USB stick, flash card, or the like. Regardless of the method of delivery and installation, the software application 34 will be stored on the memory 32 of the user device 30 for execution to perform the various functionalities of the present invention.

Upon first executing the software application 34 on the user device 30, the user device 30 will first check to see if map data and well data have been previously stored in the memory 32 of the user device 30. If the map data and well data has not been previously stored (i.e., this is the first time executing the software application 34 on a particular user device 30), the user device 30 will download map and well data from the central communication server 20 via the communications network 12.

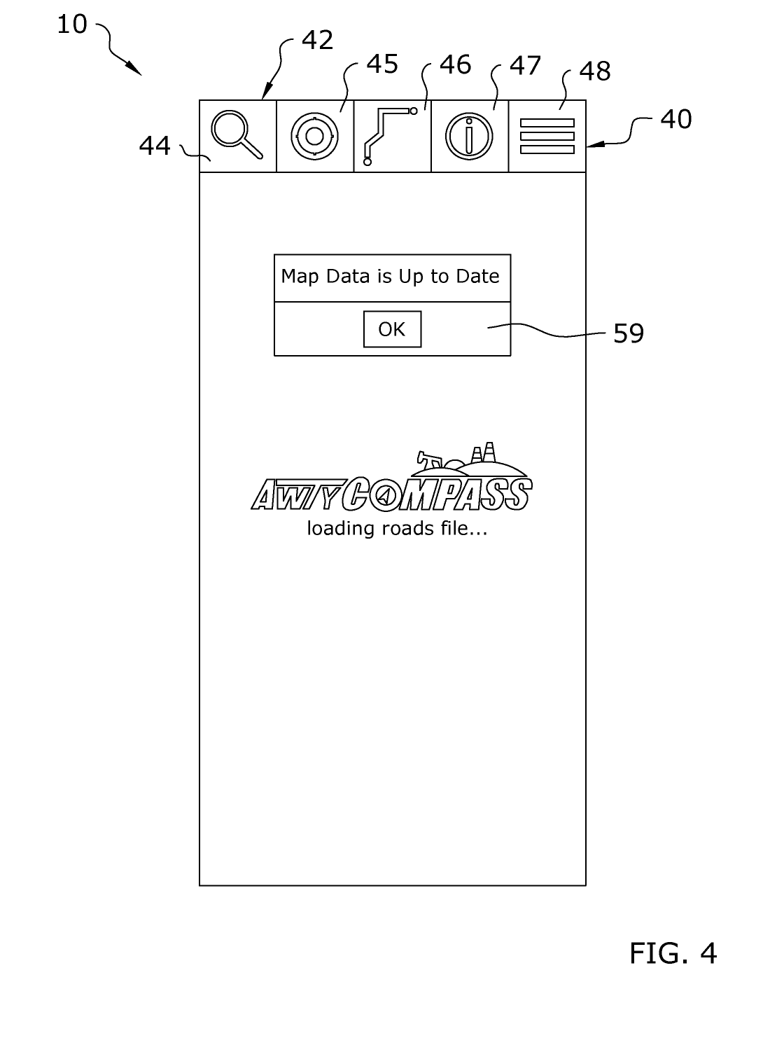

If the map data and well data already are already stored on the user device 30, the user device 30 will still connect with the central communication server 20 and query to ensure that the map and well data is up-to-date. If it is not, the central communication server 20 will transmit the updated map and well data to the user device 30 for storage in memory 32. Messages 59 may be shown on the user interface 40 to indicate the status of the download as shown in FIGS. 3-4.

After ensuring the map and well data are current, the map display 41 and menu bar 42 will be displayed as shown in FIG. 5. The user location will be shown on the map display 41 by a user location indicator 39, shown in the figures as comprising a triangle. Any wells in the area shown on the map display 41 will be shown by well indicators 43 such as circles as shown in the exemplary figures.

As previously discussed, the menu bar 42 includes a plurality of selectors 44, 45, 46, 47, 48 which each perform their own functionality. In a preferred embodiment, the menu bar 42 includes a search selector 44, a user location selector 45, a navigation selector 46, an information selector 47, and an option selector 48. Each of the selectors 44, 45, 46, 47, 48 may be selected (such as by a finger, stylus, mouse pointer, or voice command) from the user interface 40 by the user to perform different functions of the present invention.

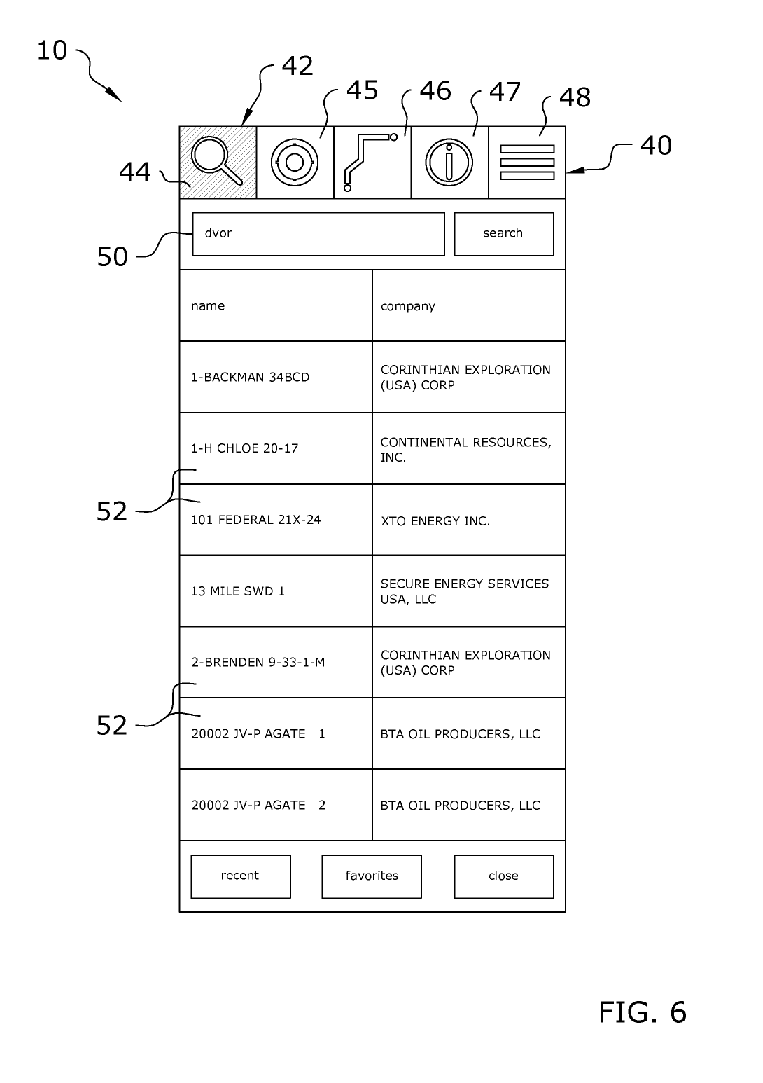

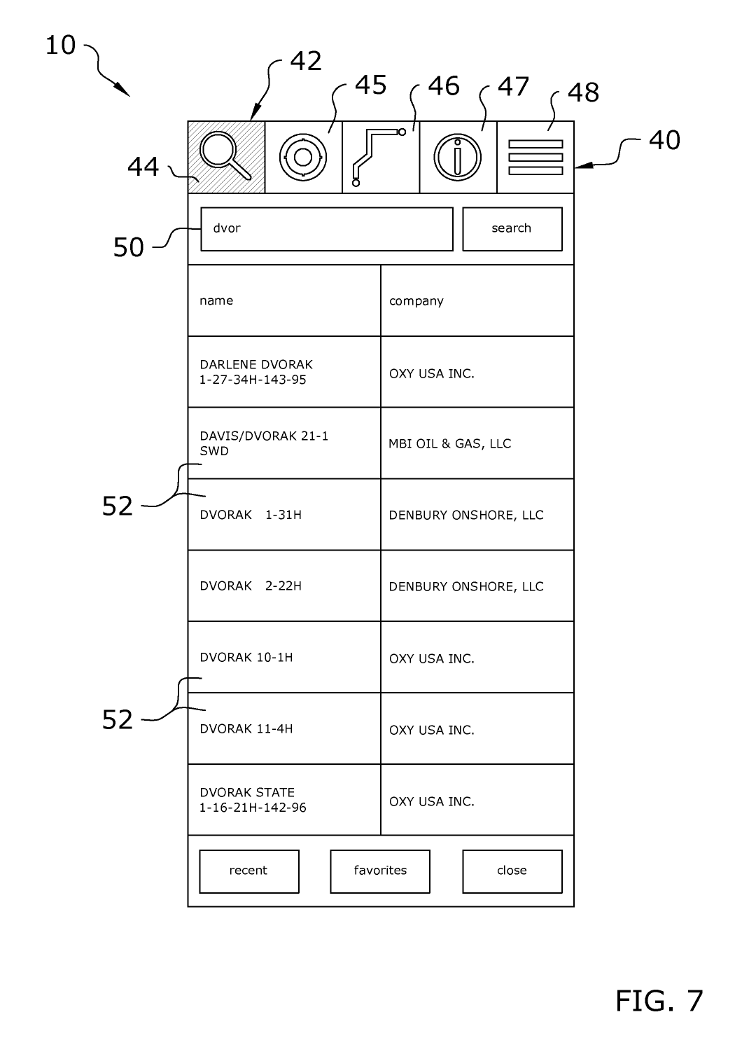

The search selector 44 on the menu bar 42 will bring up a search bar 50 as shown in FIG. 6. Underneath the search bar 50 is a well listing 52 which includes all of the wells stored within the memory 32 of the user device 30 as well data received from the central communication unit 20. By entering at least three letters into the search bar 50, the well listing 52 will limit itself to wells which include those three letters as shown in FIG. 7. Entering more letters into the search bar 50 may further refine the search.

Selecting one of the wells within the well listing 52 will bring up a well menu 53. The well menu 53 will include a number of options which may be selected by the user to perform various functionality with respect to the selected well. In a preferred embodiment as shown in FIG. 8a, options within the well menu 53 may include “view on map”, “navigate to”, “view details”, “add to favorites”, and “back”.

If a user selects “view on map” from the well menu 53, the map display 41 will be shown and centered on the selected well, which is represented by a well indicator 43. If a user selects “navigate to”, the user device will display either a navigation display 56 over the map display 41 showing a route or a directions display 57 which provides step-by-step instructions on travelling from the user's location to the selected well.

If a user selects “view details”, a well details 54 pop-up will be shown on the user interface 40 as shown in FIG. 8b. It should be noted that the well details 54 may also be shown by simply selecting a well indicator 43 from the map display 41. The well details 54 may include various information about the selected well, including the well name, the company owning the well, the file number, an API key, and the latitudinal and longitudinal coordinates of the selected well. Additional information may be included in alternate embodiments of the present invention.

By selecting “add to favorites”, the user may add that particular well to a list of favorites which may be easily accessed at a later time, such as using the options menu 55 from the options selector 48. This is useful if there is a particular well that a user will visit more frequently and thus wishes to access more rapidly without necessity of a search in the future.

Selecting the user location selector 45 will center the map display 41 on the user's location. The user's location on the map display 41 will be represented by a user location indicator 39 as shown in FIG. 5. This feature can be useful if a user is exploring the geographical area using the map display 41, such as by swiping the map display 41 or using the zoom selector 49, and cannot easily retrace his/her steps to locate his/her current location.

Selecting the navigation selector 46 from the menu bar 42 will automatically generate navigational directions between the user's current location and any selected well. If a well is not selected, the user interface 40 will request that the user select a well prior to selecting the navigational selector 46 again. The user may select a well using either the well indicator 43 on the map display 40 or the well listing 52 which is populated after conducting a search using the search bar 50.

In either case, the navigation selector 46 will calculate and display a route upon selection of the navigation selector 46 when a well has been previously chosen. The route may be shown directly on the map display 41 via a navigation display 56 showing a line between the user location indicator 39 and the well indicator 43 as shown in FIG. 9 or step-by-step instructions may be provided through a directions display 57 as shown in FIG. 10. The user will be given the option of switching between the navigation display 56 and the directions display 57 at-will depending on his/her desired form of navigational directions. If the user device 30 supports it, audio directions may be provided to aid in navigating to the selected well(s).

Selecting the information selector 47 from the menu bar 42 will display the well details 54 screen on the user interface 40 as shown in FIG. 8b. This well details 54 screen includes various information relating to the selected well as discussed previously. If a well has not been selected when the information selector 47 is selected, the present invention will prompt the user to select a well and then access the information selector 47 again, such as through a pop-up message 59.

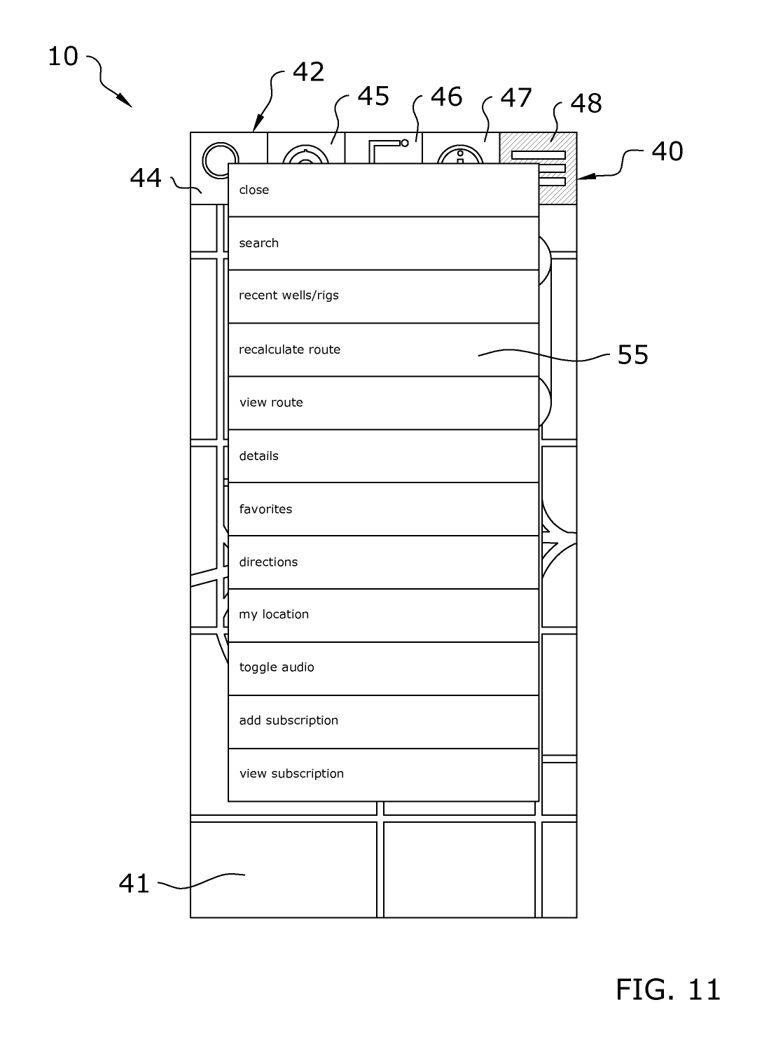

Selecting the options selector 48 from the menu bar 42 will bring up an options menu 55 which includes a plurality of options, some of which are duplicative of options which are achievable through other areas of the user interface 40 (for example, navigational options). The plurality of options included on the options menu 55 may vary in different embodiments. In a preferred embodiment as shown in FIG. 11, options may include “close”, “search”, “recent wells/rigs”, “recalculate route”, “view route”, “details”, “favorites”, “directions”, “my location”, “toggle audio”, “add subscription”, and “view subscription”.

The “close” option will close the options menu 55. The “search” option will bring up the search bar 50 as if the search selector 44 had been selected. The “recent wells/rigs” option will display a listing of recent wells which have previously been selected and/or viewed by the user. The “recalculate route” option will allow the user to recalculate a route, such as if there is traffic, if the user strays from the previously-set path, or if the user desires different routing. The “view route” option will bring up the navigation display 56 while the “directions” option will bring up the directions display 57.

The “details” option will bring up the well details 54 listing previously discussed if a well has been previously selected. The “favorites” option will bring up a listing of favorite wells which were previously saved using the “add to favorites” option from the well menu 53. The “my location” option will perform the same functionality of the user location selector 45; centering the map display 41 on the user location indicator 49. The “toggle audio” option will toggle audio between on/off if the user device 30 supports such a feature. The “add subscription” option may be utilized to add a subscription to the software application 34 and the “view subscription” option may be utilized to view details about a previously added subscription, such as the time left on the subscription before renewal.

By utilizing the present invention, an individual can easily view information relating to wells or navigate to wells without requiring a constant streaming connection between the user device 30 and the central communication unit 20. This provides a clear improvement over prior art which requires constant streaming of such data. As the user utilizes the present invention, the user device 30 will record the user's movements in its memory 32 as navigational data which will be transmitted upon closing of the software application 34 to the central communication unit 20 for processing. It should be appreciated that the functionalities performed herein may vary in different embodiments, with more or less functionality being offered depending on the needs of the particular user base for the present invention.

In some embodiments, route planning may be optimized based on weight restrictions on the roads which the user will be travelling. This feature can be beneficial for haulers so that they can avoid potential legal implications or delays due to rerouting if they encounter a road which the user's vehicle may be overweight for. In one embodiment, the user device 30 may prompt a user to enter the weight of the user's vehicle. This data will be utilized by the user device 30 in planning the route to ensure that no roads are utilized which the user's vehicle is overweight for.

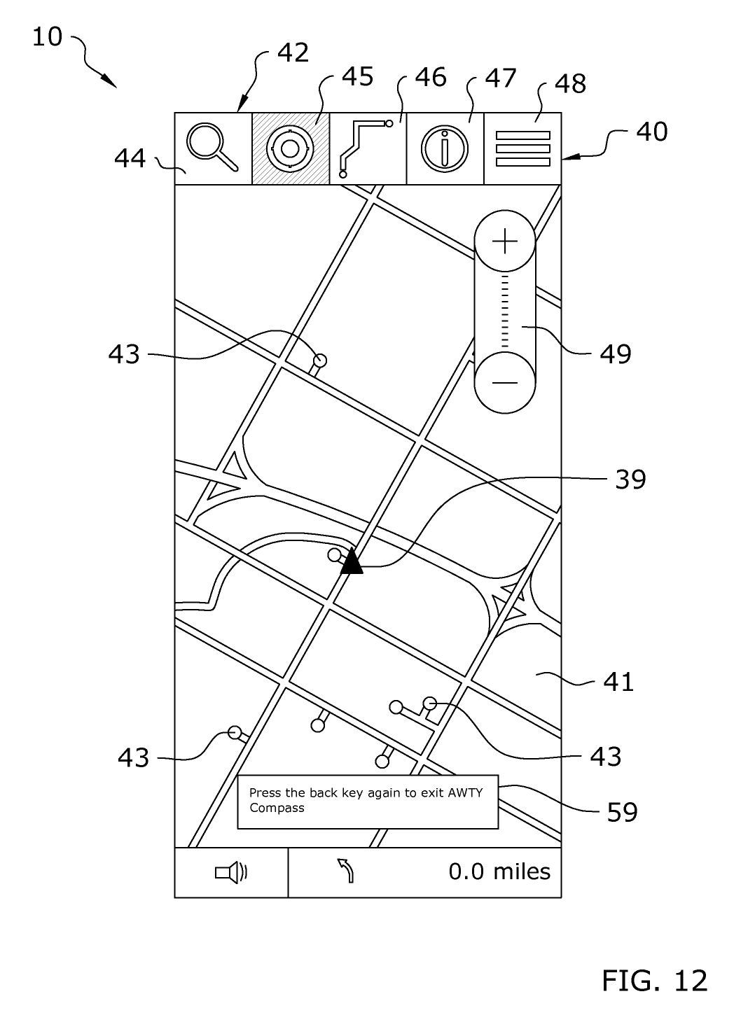

As shown in FIG. 20, upon completion of use of the present invention, a user will select the “back” or “close” button on the user device 30. The user interface 40 will display a message 59 requesting that the “back” or “close” button be selected again to exit the software application 34 as shown in FIG. 12. This feature prevents a user from inadvertently or prematurely exiting the software application 34.

Upon selecting the “back” or “close” button again, the user device's 30 GPS navigational system 36 will be disabled and the user device 30 will stop storing navigational data in its memory 32. A connection will be established with the central communication unit 20, at which time the navigational data (such as via a GPX file) will be transmitted to the central communication unit 20 from the user device 30. The central communication unit 20 will utilize this navigational data to update the map and well data in its database 22 to reflect newly up-to-date information recorded during use of the user device 30.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A method for providing a navigation system, comprising:
providing a central communication unit;
providing a user device, wherein said user device executes a software application;
establishing a first connection between said user device and said central communication unit;
transferring map and well data from said central communication unit to said user device;
storing said map and well data on a memory of said user device;
closing said first connection;
displaying a user interface including a map display showing a geographical area on said user device;
searching for a well on said user device;
providing navigation between a current location and said well by said user device;
recording movements of said user device as navigational data in said memory of said user device;
closing said software application;
establishing a second connection between said user device and said central communication unit; and
transferring said navigational data from said user device to said central communication unit.

2. The method of claim 1, wherein said geographical area consists of an oil-producing region.

3. The method of claim 1, wherein said user interface includes a menu bar.

4. The method of claim 3, wherein said menu bar includes a search selector.

5. The method of claim 4, further comprising the steps of selecting said search selector, entering one or more letters to identify said well, and displaying a well listing by said user device.

6. The method of claim 5, further comprising the steps of selecting said well from said well listing and displaying well details related to said well on said user interface.

7. The method of claim 6, wherein said well details include a name of said well, a company owning said well, and an API key.

8. The method of claim 1, wherein said user interface includes a user location selector.

9. The method of claim 8, further comprising the steps of selecting said user location selector and centering said map display on said current location.

10. The method of claim 1, wherein said user interface includes a navigation selector.

11. The method of claim 10, further comprising the steps of selecting said navigation selector to display a route between said current location and said well.

12. The method of claim 1, wherein said user interface includes an information selector and further comprising the steps of selecting said information selector and displaying well details on said user interface.

13. The method of claim 1, wherein said map display includes a user location indicator identifying said current location.

14. The method of claim 13, wherein said map display includes a well indicator identifying said well.

15. The method of claim 14, further comprising the step of selecting said well indicator to display well details relating to said well.

16. The method of claim 1, wherein said user device is not communicatively interconnected with said central communication unit between said first connection and said second connection.

17. The method of claim 1, wherein said map display displays both private roads and public roads, wherein said private roads include lease roads and off-road trails.

18. The method of claim 1, wherein said central communication unit includes a database, wherein said map data and said well data are stored on said database.

19. The method of claim 18, further comprising the step of updating said map data and said well data on said database of said central communication unit with said navigational data from said user device.

20. The method of claim 1, wherein said user device comprises a mobile phone.
